(19) United States
(12) Patent Application Publication
(10) Pub. No.: US 2025/0103971 A1
(43) Pub. Date: Mar. 27, 2025

(54) Method and System for Providing a Function Recommendation in a Vehicle

(71) Applicant: Bayerische Motoren Werke Aktiengesellschaft, Muenchen (DE)

(72) Inventors: Daniel Homola, Muenchen (DE); Christian Micus, Unterhaching (DE)

(21) Appl. No.: 18/834,085

(22) PCT Filed: Nov. 25, 2022
(86) PCT No.: PCT/EP2022/083270

§ 371 Date: Jul. 29, 2024

(30) Foreign Application Priority Data
Feb. 16, 2022 (EP) 22156944.5

(51) Int. Cl. G06N 20/20; B60K 35/26; B60K 35/28; G06N 3/09

(52) U.S. Cl. CPC G06N 20/20; B60K 35/265; B60K 35/28; G06N 3/09; B60K 2360/167; B60K 2360/178

(57) ABSTRACT

A computer-implemented method for providing a function recommendation in a vehicle is disclosed herein. The method includes loading a recommendation model, and receiving context information acquired from at least one sensor of the vehicle, the context information in particular comprising a geographical location of the vehicle. The method further includes determining at least one function including a vehicle function using the context information and the recommendation model, and providing a function recommendation associated with the vehicle function using a display or a voice assistant of the vehicle.

### CROSS-REFERENCE TO RELATED APPLICATIONS

The present application is the U.S. national phase of PCT Application PCT/EP2022/083270 filed on Nov. 25, 2022, which claims priority of European patent application No. 22156944.5 filed on Feb. 16, 2022, the entire contents of which are incorporated herein by reference.

### FIELD

The present application is related to motor vehicle functionality, and particularly driver-assistance systems in motor vehicles.

### BACKGROUND

Modern vehicles have a wide range of vehicle functions that generally aim to increase safety and driving comfort for the driver as well as the vehicle occupants. In particular, various driver-assistance systems (ADAS) exist that are designed to prevent accidents by vehicle collisions or to assist the driver in specific situations another way.

For example, a lane keeping system (LKS) is a system that, first, warns the driver if vehicle sensors detect that the vehicle begins to move out of its lane. Typically, the warning is signaled acoustically and/or optically. If the driver does not correct the lane by appropriate countersteering, the LKS automatically initiates steps to prevent the vehicle from moving out of its lane, e.g., by controlling the steering of the vehicle. This way, the LKS aims to prevent collisions. In case of LKS, the vehicle sensors may include a video sensor, e.g., a video camera configured to detect lane markings.

As certain vehicle functions may only be available in particular driving situations, these functions are deactivated by default and need to be activated or set-up manually by the driver. However, drivers may forget about the availability of the function while driving or are simply overwhelmed with the decision due to the plurality of functions in modern vehicles. This may lead to the problem that certain functions are rarely used by drivers, even though drivers would benefit from activating the functions. From a safety point of view, it is also desirable to maximize the usage rate of ADAS.

For this reason, concepts are known to provide the driver with a proactive function recommendation. That is, in a specific driving situation, the driver is encouraged automatically by the vehicle to activate a certain function. In particular, the vehicle may verify that the requirements for a certain function are satisfied and the activated function appears to be a supportive experience for the driver. Then, a notification may be displayed on a head-up display of the vehicle, encouraging the driver to activate the function. In response to the function recommendation, the driver may activate the function or decide to leave the function deactivated.

For example, a recommendation for the lane keeping system of a vehicle may be provided when the following requirements are satisfied: the driving speed is in a range of 60 to 140 km/h; and no turn signal is set; and lane markings have been detected.

Therefore, to decide about a function recommendation, the current driving situation is considered at a high level of abstraction and is evaluated with respect to requirements that are pre-determined by vehicle developers. Such requirements are called static requirements in the following.

Often, the static requirements are chosen in a rather strict manner to avoid inadequate function recommendations and to guarantee proper operation of the function. Another reason for restrictive function recommendation is that inappropriate function recommendations may lead to distraction and frustration of the driver.

In view of the foregoing, it would be advantageous to provide a computer-implemented method for providing function recommendation in a vehicle. In particular, it would be advantageous to improve the function recommendation such that the recommended function is more likely to provide a supportive experience for the driver in the current driving situation. Moreover, it would be advantageous to provide a corresponding vehicle and a system to implement the method.

### SUMMARY

A computer-implemented method is disclosed herein for providing a function recommendation in a vehicle. The method comprises the following steps: loading a recommendation model; receiving context information acquired by using at least one sensor of the vehicle, the context information in particular comprising a geographical location of the vehicle; determining a function, in particular a vehicle function, using the context information and the recommendation model; providing a function recommendation associated with the function, in particular using a display and/or a voice assistant of the vehicle.

A core aspect of the present disclosure is that function recommendations are provided in a context-specific manner using a recommendation model and context information, rather than based on pre-determined criteria. In particular, the recommendation model can be based on artificial intelligence, e.g., by comprising an artificial neural network.

In order to characterize the current driving situation and environmental parameters of the vehicle, the method comprises receiving context information that are acquired by using at least one sensor of the vehicle.

In the context of this application, the term context information relates to any set of information descriptive of the current driving situation and environment of the vehicle. In particular, the context information may comprise driving parameters of the vehicle (e.g., driving speed, standard deviation of driving speed, time expired since start of the trip, etc.) as well as environmental parameters (e.g., geographical location of the vehicle, a road property, outdoor temperature, etc.).

Using the recommendation model and the received context information, the method determines a function, in particular a vehicle function, to be recommended.

The term vehicle function relates, in the context of this application, to any function associated with operating or using the vehicle, in particular driver-assistance systems and comfort functions of the vehicle. In particular, the activated function vehicle function may lead to a supportive experience for the driver in the current situation, e.g., as driving becomes more convenient for the driver or the safety is increased.

The determining of the function may in particular include a database lookup, wherein the database provides functions that are basically available in the respective vehicle. The database may be stored on an on-board storage of the vehicle or provided by an external server. Moreover, determining of the function may include determining a ranking of functions.

After determining the function, the method provides a function recommendation associated with the function in the vehicle. This may, in particular, comprise displaying an activation incentive on a display of the vehicle, playing a notification sound using a vehicle speaker, etc.

This way, the method enables to identify and recommend a function that is likely to match the current driving situation and context, and therefore may outperform function recommendation based on static requirements. The function recommendation can be provided to the driver in a convenient way, using appropriate input and output devices of the vehicle. In particular, drivers are enabled to activate a recommended function without significant effort, causing him being distracted in road traffic. Generally, this improves usability and safety of the vehicle.

In at least one embodiment, the outcome of the described method will impact on I change the functionality of the vehicle. For example, after the function recommendation is provided, the vehicle will behave in a different manner, e.g. by immediately activating the recommended function and/or by responding differently to an input received by the vehicle (e.g. a voice signal, a gesture or the activation of a button).

In one embodiment, the recommendation model classifies the context information as member of a first group or member of a second group with respect to a function. In particular, the first group can be associated with a supportive experience for the driver.

According to this embodiment, for any function under consideration, it can be checked whether the context information, representing the current driving situation, is classified as member of the first group or member of the second group. In the first case, activating the function in the current driving situation may lead to a supportive experience by the driver and the function is qualified as candidate for recommendation. This way, the determining of the function can be based on the classification of context information by the recommendation model.

In one embodiment, the method comprises determining a road section based on the geographical location of the vehicle. In particular, the determining of the road section may comprise sending a request to an external server, the server providing a mapping between geographical locations and road sections. According to this embodiment, determining of the function further uses at least one key performance indicator of the determined road section. The at least one key performance indicator is a numerical value associated with a function and specific for a road section.

In particular, a key performance indicator can be one of the following: activation ratio=n_activation/n_traversals; function usage ratio=n_activeT reversals I n_traversals; deactivation ratio=n_deactivation/n_activeTraversals; first group ratio=n_firstGroup/n_activation, with the following definitions: reactivation: total number of function activations on road section; n_deactivation: total number of function deactivations on road section; n_traversals: total number of traversals of road section; n activeTraversals: total number of traversals of the road section with activated function; n_firstGroup: total number of function activations associated with context information classified as member of a first group.

The key performance indicators as defined above are numerical or statistical indicators for the usage of a function with respect to a certain road section. According to this embodiment, determining of the function can be based further on key performance indicators, which take the geographical context of the vehicle (road section) into account. This way, the function recommendation can be further improved.

In one embodiment, the recommendation model comprises at least one artificial neural network and/or uses at least one random forest model. Preferably, the recommendation model is trained by the training method described later in this description.

In particular, an artificial neural network is able to perform classification of unknown inputs. The quality of classification can be improved efficiently, for example by means of supervised learning methods. The learning method may adjust internal weights of the artificial neural network in order to minimize incorrect classifications of training datasets. This way, an artificial neural network is able to learn even complicated non-linear classification functions.

In one embodiment, the context information comprises at least one piece of information indicative of: a time and/or date, a driving speed, a road property, a weather condition, a number of passengers in the vehicle, a mileage of the vehicle, a time expired since start of the trip, a standard deviation of a driving speed.

The pieces of information mentioned above can be easily acquired by corresponding vehicle sensors and/or on-board computer systems of the vehicle. By using context information including these pieces of information, it is possible to precisely describe the situation where the vehicle is currently in. In particular, context information is not limited to internal parameters of the vehicle, but may also include the geographical position of the vehicle and/or weather information. This may crucially improve the quality of function recommendation, since these external parameters may be correlated to driver's preferences regarding the usage of certain functions.

In one embodiment, the function is a vehicle function of the vehicle and one of: cruise control, adaptive cruise control, lane keeping system, lane departure warning, lane change assistance, automatic parking, crosswind stabilization.

These functions are well suited for proactive function recommendations. Activation of these vehicle functions in a suitable driving situation can lead to a supportive experience for the driver and therefore improve the comfort of driving. Significantly, traffic safety may be increased this way since the activated functions may prevent vehicle collisions.

In one embodiment, providing the function recommendation comprises: displaying an activation incentive on a display of the vehicle; playing a sound on a speaker of the vehicle; using a voice assistant of the vehicle (100); and/or modifying programming of a control element such that operating the control element causes sending a control command for activating the function.

According to this embodiment, providing of the function recommendation is directly linked with actions in the vehicle that call the driver's attention to the recommended function and/or to facilitate activation of the recommended function.

The activation incentive may be a visual notice indicative of the recommended function, for example the text “Turn LKS on?”. The activation incentive may be displayed on a display of the vehicle, for example, a head-up display or the display of the on-board computer.

In particular, the vehicle may comprise a programmable control element, for example, an “OK” control button at the steering wheel, such that pressing the control button triggers the action according to the programming. Now, if providing the function recommendation comprises modifying the programming of the control element as described above, the driver can activate the recommended function by pressing the control button.

According to this embodiment, usability of the vehicle is improved. Moreover, the driver's gaze is not distracted from the road, as it could be the case when he needs to find the control element associated with the recommended function on the dashboard of the vehicle.

In one embodiment, the method further comprises the step of: creating an event dataset comprising context information and event information; sending the event dataset to a server, in particular using a communication unit of the vehicle.

In particular, the context information may comprise the geographical location of the vehicle as well as further pieces of information as described above. The event information comprises a function, a binary value indicative of an activation or deactivation event of the function, and a timestamp associated with the activation or deactivation event.

For example, an event dataset may be indicative of: the event that the LKS is activated; the point of time of activation; the driving speed at time of activation.

According to this embodiment, statistical data about function usage can be collected in the vehicle and the corresponding event datasets can be sent to a server for further processing. In particular, the server may use the received event datasets to improve a recommendation model stored on the server as described in connection with the following embodiment.

The present disclosure further includes a computer-implemented training method for training a recommendation model for function recommendation in a vehicle. The training method comprises: receiving a plurality of event datasets, each event dataset comprising context information and event information, wherein the event information comprises a function, a (binary) value indicative of an activation or deactivation event of the function, and a timestamp associated with the activation or deactivation event; generating training datasets using the event datasets, each training dataset comprising context information, a function, and an activation duration of the function; assigning a label to each training dataset, wherein the label classifies the training dataset as member of a first group or as member of a second group; performing a supervised learning of the recommendation model by using the training datasets and the associated labels.

According to this embodiment, the classification performed by the recommendation model can be improved by means of a supervised learning process.

As a first step of the training method, event datasets are received, wherein the event datasets are descriptive of contexts where an activation or deactivation of a function has occurred in a vehicle. In particular, the event datasets may be created in a vehicle and sent to a server as described in the previous embodiment. In particular, the server may adapted to store a recommendation model and to execute the training method.

In a next step, training datasets are generated on the basis of the received event datasets. Training datasets comprise, in addition to the context information and the function, an activation duration of the function. The activation duration of the function can be obtained from a pair of a first event dataset and a second event dataset, wherein the first event dataset is indicative of the activation time of a function in a vehicle and the second event dataset is indicative of the deactivation time of the function in the vehicle.

The generating of training datasets may also comprise assigning an identifier of a road section to a geographical location. In other words, the geographical locations, in particular GPS positions, from event datasets may be transferred to road section identifiers for the training datasets. This may produce training datasets of higher quality as road section identifier provide a reasonable abstraction of the precise geographical location of the vehicle.

In a further step, each training dataset is assigned a label, wherein the label classifies the training dataset as member of a first group or as member of a second group. The assigned label represents the desired classification (output) of the recommendation model with respect to the training dataset (input). In particular, a training dataset should be labelled as member of a first group if the training dataset represents a context where recommendation of the function appears desirable. Preferably, the labelling is performed automatically by means of a labelling algorithm, rather than manually.

The labelled training datasets are used to perform a supervised learning of the recommendation model. In particular, the training datasets together with the associated labels are input-output pairs that can be fed to a learning algorithm. The learning algorithm may adjust internal parameters of the recommendation model (for example, weights of an artificial neural network) in order to minimize incorrect classifications for the set of training datasets.

In one embodiment, the training method is characterized in that a training dataset is assigned a label classifying the training dataset as member of the first group if the activation duration exceeds a threshold duration. The threshold duration may be specific for a function. In particular, the threshold duration can be less than 15 minutes or less than 10 minutes or less than 5 minutes, preferably 3 minutes.

This embodiment is motivated by the assumption that if a function stays activated for at least a minimum duration, most likely the driver appreciates a supportive experience due to the function. In contrast, a short activation duration may indicate that the driver is dissatisfied with the function in the respective context.

From another perspective, according to this embodiment, the recommendation model is trained to predict whether activation of a function in a given context will lead to a supportive experience for a forthcoming time interval.

According to this embodiment, the labelling of training datasets can be performed efficiently by means of a labelling algorithm. The criterion, whether the activation duration exceeds the threshold duration, can be verified very efficiently.

Alternatively to the supervised learning process described above, a recommendation model for function recommendation in a vehicle may be trained by means of an unsupervised learning process. Based on event datasets, the set of all context information associated with a function activation, called activation contexts, can be determined. The recommendation model can be trained to decide whether a given context information is similar to an activation context. In this case, activation of the function can be recommended. With an unsupervised learning process, the necessity to label all training datasets is avoided.

In at least some embodiments, methods disclosed herein are carried out by a computer readable medium. The computer readable medium stores instructions that when executed by at least one processor cause the at least one processor to implement a method as described above.

Regarding the computer readable medium, similar or identical benefits result as described in connection with the above methods. Embodiments of the present disclosure further include a vehicle comprising:
at least one sensor, in particular a position determination sensor, in particular a GPS sensor;
a computer readable medium, in particular as described above;
a vehicle computing unit.

The vehicle computing unit is adapted to a) acquire at least one signal of the at least one sensor; b) determine context information based on the acquired signal for feeding to the recommendation model; c) receive a recommendation, the recommendation indicating a function to be used and being determined based on an output of the recommendation model, the recommendation model in particular being stored on a server; d) use the recommendation to adapt the functionality of the vehicle. The vehicle computing unit (which may also be referred to herein as “controllers,” or “control units”) may be provided by any of various controllers as are commonly known to those of ordinary skill in the art. Controllers include circuits (e.g., integrated circuits) that contain typical functionality of central processing units (CPU) and are configured to perform various calculations and analysis based on manufacturer programming instructions. One example of a controllers used in vehicles is that of any of various Engine Control Units (ECNs) as are commonly used by different manufacturers in modern automobiles.

The vehicle as described above is preferably configured to provide function recommendations in an offline or online mode. In the offline mode, the vehicle has a local copy of the recommendation model and a vehicle communication unit is configured to implement the method using vehicle components. In the online mode, the determining of the function is performed by an external server providing the recommendation model; the vehicle sends context information as a request to the server and receives the determined function, wherein sending and receiving is performed using a communication unit of the vehicle.

In the offline mode, the vehicle has a large degree of autonomy, in particular, it is not necessary that the vehicle can establish a (wireless) connection to the server. The online mode, on the other hand, enables that the vehicle can access a latest version of the recommendation model without the need of a complete download. This can save resources of the communication channel between vehicle and server.

In one embodiment, the vehicle further comprises a programmable control element, in particular a control button, and the vehicle computing unit is adapted to modify programming of the control element such that operating the control element causes sending a control command for activating the function.

Moreover, embodiments of the present disclosure include a system for providing a function recommendation in a vehicle. The system comprises: a server configured to store a recommendation model and/or to train the recommendation model, in particular according to the training method described above; and a vehicle as described above, wherein a communication unit of the vehicle is configured to a) receive the recommendation model and/or a function from the server and/or b) to send context information and/or event datasets to the server.

Regarding the vehicle and the system, similar or identical benefits result as described in connection with the above methods.

It is explicitly pointed out that all described aspects can be combined with each other as desired. In particular, the aspects described with respect to the methods are also disclosed for the vehicle and/or the system and vice versa.

### BRIEF DESCRIPTION OF THE DRAWINGS

In the following, embodiments of the disclosure are described with respect to the figures, wherein

FIG. 1A shows a system according to one embodiment, the system comprising a vehicle and a server;

FIG. 1B shows the interior of the vehicle from FIG. 1B;

FIG. 2 shows a schematic view of a method according to one embodiment performed by the system from FIG. 1A;

FIGS. 3A and 3B show two situations in which a method according to one embodiment provides different function recommendations;

FIG. 4A shows event datasets according to one embodiment;

FIG. 4B shows training datasets corresponding to the datasets from the embodiment according to FIG. 4A and corresponding labels.

In the following description, same reference signs are used for same parts and parts with the same effect.

### DESCRIPTION

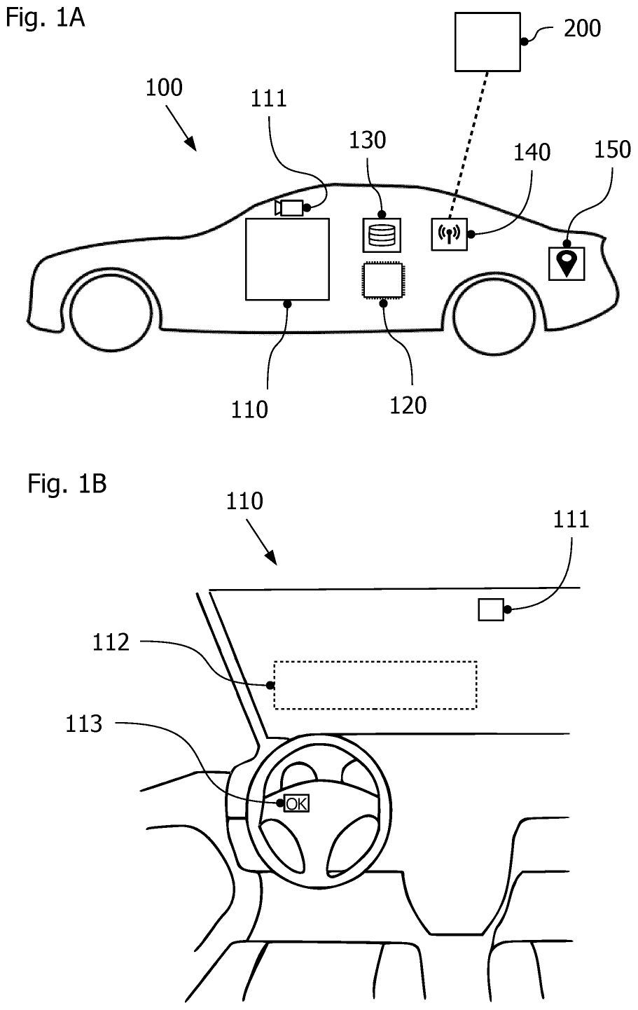

FIG. 1A shows a system according to one embodiment of the present disclosure. In particular, FIG. 1A shows the main components of the vehicle 100 and the server 200. The vehicle 100 has a video camera 111 configured to provide sensor signals for the lane assist system of the vehicle 100. Moreover, the vehicle 100 has a computing unit 120 and a storage unit 130. The computing unit 120 has a processor and the storage unit 130 stores instructions that, when executed by the processor, cause the processor to implement a method for providing a function recommendation as described above. For communicating with the server 200, the vehicle comprises a communication unit 140 (the communication link is represented by the dashed line in FIG. 1A). For acquiring the current position of the vehicle 100, the vehicle 100 further comprises a GPS module 150. The interior 110 of the vehicle 100 is explained in more detail using Figure IB.

As depicted in FIG. 1B, the vehicle 100 has a head-up display 112, enabling the driver to read the provided information without having to take his eyes off the road. The video camera 111 for the lane assist system is arranged in the interior mirror of the vehicle 100 and directed to the road, such that lane markings can be detected by the video camera 111. Moreover, a programmable control button 113 is located on the steering wheel of the vehicle 100. By pressing the control button 113, one or more control commands are sent to a vehicle bus, according to the programming. In particular, the control button 113 enables the driver to activate a vehicle function that has been recommended recently.

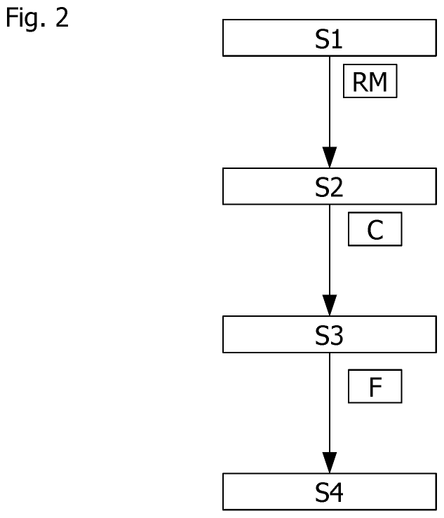

FIG. 2 shows a schematic view of a method for providing function recommendation in the vehicle 100 performed by the system from FIG. 1A. According to this embodiment, the vehicle operates in the offline mode, that is, the vehicle has a local copy of the recommendation model and the method steps are performed by components of the vehicle 100.

In step S1, the vehicle 100 receives the recommendation model RM from the server 200 by means of the communication unit 140 and loads the recommendation model RM into the storage unit 130. In particular, step S1 may be performed as initial setup step and not immediately before the determining of the function according to step S2.

In step S2, the vehicle computing unit 120 receives context information C. For this purpose, the vehicle computing unit 120 acquires the sensor data of the video camera 111, the geographical position provided by the GPS module 150, and the current time from a head unit (not shown) of the vehicle 100. Specifically, the context information C may comprise the following information: lane markings detected: yes; GPS position: 48.2255, 11.6316; current time: 12:57 pm.

In step S3, a request to the recommendation model RM is sent, the request comprising the context information C. According to the response of the recommendation model, the function F is determined as function to be recommended. In particular, the function F may be the lane keeping system of the vehicle 100.

In step S4, a function recommendation associated with the function F is provided in the vehicle. For this purpose, the vehicle computing unit 120 sends a control command over a vehicle bus that causes the head-up display 112 to display the text “LKS recommended. Press OK to activate.”. In addition, the vehicle computing unit 120 causes modifying programming of the control button 113 on the steering wheel such that pressing the control button 113 causes sending a control command for activating the function F, i.e., the lane keeping system. This way, the driver is provided with the recommendation for activating the LKS and the driver obtains a convenient method to trigger activation of the LKS in the vehicle 100.

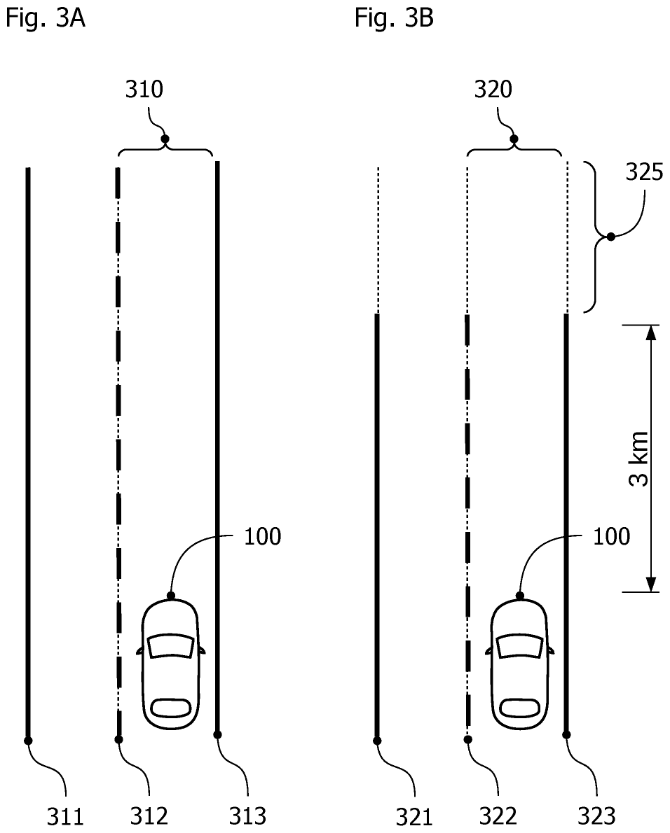

In FIGS. 3A to 3B, two situations are depicted, wherein a method according to one embodiment provides different function recommendations.

FIG. 3A shows a two-lane road with lane markings 311, 312, and 313, the road being located at a first geographical location. The vehicle 100 drives on the right lane 310, which is limited by lane markings 312 and 313. According to this embodiment, it is assumed that the method for providing function recommendation recommends activating the LKS in light of the respective context information. In particular, the video camera 111 of the vehicle 100 detects the line markings 312 and 313 (similar as described in connection with FIG. 2).

FIG. 3B shows a setting similar to FIG. 3A, however, located at a second geographical location. On the lane 320, a road construction site 325 is located in a distance of 3 km ahead the vehicle 100. On the road section at the road construction site 325, the lane markings 321, 322, and 323 are broken and cannot be detected by the video camera 111. Therefore, the lane keeping system would stop working properly as soon as the vehicle 100 reaches the road construction site 325. In FIG. 3B, if function recommendation would be based on verifying static requirements, the outcome of the function recommendation would be the same as in FIG. 3A. In particular, the video camera 111 detects line markings 312, 322, 323 directly in front of the vehicle 100 and therefore activating of LKS may be recommended based on static requirements. However, according to the method described of this disclosure, function recommendation is based on context information. For the embodiment of FIG. 3B, it is assumed that based on the context information, which is different from the context information of FIG. 3B, due to the different geographic location, the recommendation model RM classifies the lane keeping system as member of the second group. That is, the LKS is not classified as qualified for recommendation. Instead, the recommendation model RM may classify the cruise control function of vehicle 100 as qualified for recommendation in the present context.

In other words, the inventive method enables that LKS is not recommended in FIG. 3B while LKS is recommended in FIG. 3A, although both settings appear similar from the vehicle's immediate perspective. The reason is that, in the embodiment of FIG. 3B, the recommendation model is trained to not recommend LKS due to the road construction site 325. The training may have been based on event datasets created by drivers traversing the road construction site 325 with deactivated LKS.

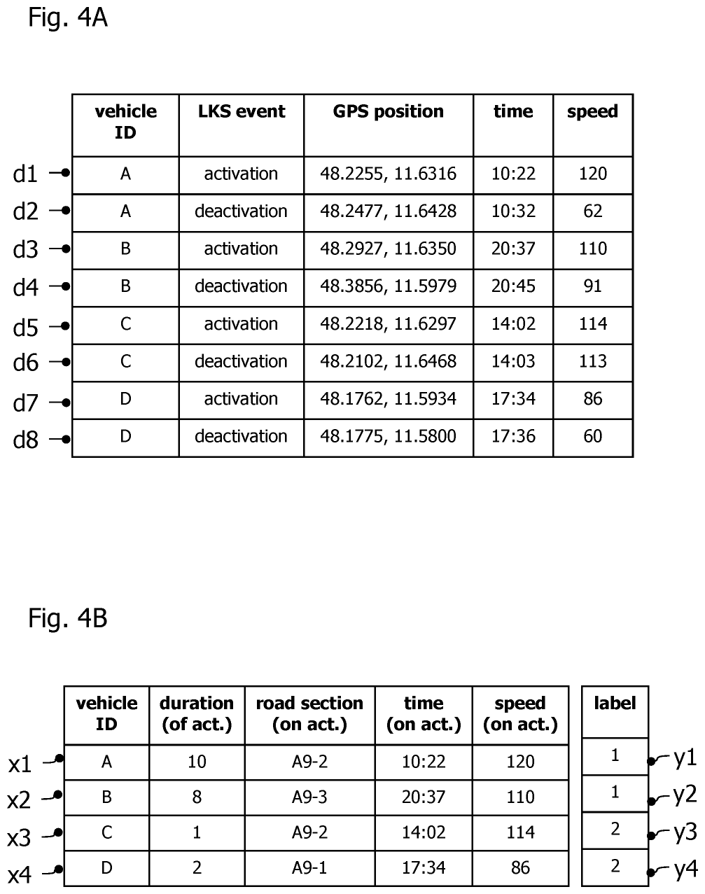

FIG. 4A shows event datasets d1, . . . , d8 according to one embodiment. The event datasets d1, . . . , d8 are indicative of event information with respect to activations or deactivations of the LKS in four different vehicles, the vehicles being identified by vehicle IDs A, B, C, and D. Moreover, the event datasets d1, . . . ,d8 are indicative of context information associated with the activation or deactivation events.

In particular, event dataset d1 indicates that in the vehicle A, the LKS has been activated at time 10:22 at a speed of 120 km/h at the GPS location “48.2255, 11.6316”. Event dataset d2 indicates that the LKS has been deactivated in the same vehicle at time 10:32 at a speed of 62 km/h at the GPS location “48.2477, 11.6428”.

FIG. 4B shows training datasets x1, . . . , x4 generated using the event datasets d1, . . . d8. In particular, training dataset x1 is generated using event datasets d1 and d2; training dataset x2 is generated using event datasets d3 and d4; training dataset x3 is generated using event datasets d5 and d6; training dataset x4 is generated using event datasets d7 and d8.

The training datasets x1, . . . , x4 comprise the vehicle ID; the activation duration of LKS (derived by subtraction of activation time from deactivation time of the corresponding event datasets); the road section on activation of LKS (derived by the GPS position of the corresponding event datasets); and context information related to the activation (time on activation, speed on activation).

As can be seen in FIG. 4B, training datasets x1 and x2 are indicative of situations where the activation duration is comparably long (exceeding 3 minutes) which can be seen as an indicator for a supportive experience for the driver. In contrast, training datasets x3 and x4 are indicative of situations where the activation duration is comparably short (less than 3 minutes) which indicates that the driver deactivated the LKS shortly after activation.

Moreover, FIG. 4B shows labels y1, . . . , y4 assigned to training datasets x1, . . . , x4, respectively. According to this embodiment, training datasets having an activation duration of more than 3 minutes have been assigned label “1”, otherwise label “2”. In particular, label “1” is assigned to training datasets x1 and x2 and classifies training datasets x1 and x2 as members of the first group. Label “2” is assigned to training datasets x3 and x4 and classifies training datasets x3 and x4 as members of the second group.

This way, training datasets x1 and x2 in connection with the labels y1 and y2 can be used to train the recommendation model RM such that context information similar to the context information of training datasets x1 and x2 are classified as members of the first group. In other words, the recommendation model RM is trained to recommend activation of LKS in contexts similar to the contexts of training datasets x1 and x2.

It will be understood that, while various aspects of the present disclosure have been illustrated and described by way of example, the disclosure described herein is not limited thereto, but may be otherwise variously embodied as suggested by the disclosure. In particular, the method for providing a function recommendation can be adapted in a way that instead of considering activation contexts of anonymous vehicles, the activation context can be related to a specific driver of a vehicle. This way, it is possible to personalize the classification of the recommendation model, which leads to improved function recommendations as the recommendation model can be trained to the specific preferences of a driver.

Moreover, the classification of context information into two groups has to be seen as an example only and more complex classifications, in particular for implementing rankings of functions, can be realized in a similar way.

Additionally, it should be noted that the methods and systems disclosed herein enable to improve the recommendation model on an iterative basis. In particular, starting from an initial recommendation model provided by a server, event data indicative of functions activations or deactivations can be continuously monitored and used to generate training data for updating the recommendation model by further training. This way, the event data can serve as feedback for previous function recommendations. The updated recommendation model can then be provided to the vehicle, such that drivers can benefit from the improved recommendation model. In particular, such updates can be provided on a regular basis.

### LIST OF REFERENCE SIGNS

100 vehicle

110 interior

111 video camera

112 head-up display

113 control button

120 computing unit

130 storage unit

140 communication unit

150 GPS module

200 server

310, 320 lane

311-313 lane marking

321-313 lane marking

325 road construction site

d1, . . . d8 event dataset

x1, . . . , x4 training dataset

y1, . . . , y4 label

C context information

F (vehicle) function

RM recommendation model

S1 step of loading the recommendation model

S2 step of receiving context information

S3 step of determining a function

S4 step of providing the function recommendation

1.-14. (canceled)

15. A computer-implemented method for providing a function recommendation in a vehicle, the method comprising:
loading a recommendation model;
receiving context information acquired from at least one sensor of the vehicle, the context information in particular comprising a geographical location of the vehicle;
determining at least one function including a vehicle function using the context information and the recommendation model; and
providing a function recommendation associated with the vehicle function using a display or a voice assistant of the vehicle.

16. The method according to claim 15, wherein the recommendation model classifies the context information as member of a first group or member of a second group with respect to the at least one function, wherein the first group is associated with a supportive experience.

17. The method according to claim 15, the method further comprising determining a road section based on the geographical location of the vehicle; wherein the determining of the at least one function further uses at least one key performance indicator of the determined road section, wherein the at least one key performance indicator is a numerical value associated with the at least one function.

18. The method according to claim 15, wherein the recommendation model comprises at least one artificial neural network or uses at least one random forest model, wherein the recommendation model is preferably trained by:
receiving a plurality of event datasets, each event dataset comprising context information and event information, wherein the event information comprises a function, a value indicative of an activation or deactivation event of the function, and a timestamp associated with the activation or deactivation event;
generating training datasets using the event datasets, each training dataset comprising context information, the function, and an activation duration of the function;
assigning a label to each training dataset, wherein the label classifies the training dataset as member of a first group or as member of a second group; and
performing a supervised learning of the recommendation model by using the training datasets and the associated labels.

19. The method according to claim 15, wherein the context information comprises at least one piece of information indicative of: a time or date, a driving speed, a road property, a weather condition, a number of passengers in the vehicle, a mileage of the vehicle, a time expired since start of the trip, a standard deviation of a driving speed.

20. The method according to claim 15, wherein the at least one function includes at least one of: cruise control, adaptive cruise control, lane keeping system, lane departure warning, lane change assistance, automatic parking, crosswind stabilization.

21. The method according to claim 15, wherein providing the function recommendation comprises:
displaying an activation incentive on the display of the vehicle;
playing a sound on a speaker of the vehicle;
using a voice assistant of the vehicle; or
modifying programming of a control element such that operating the control element causes sending a control command for activating the vehicle function.

22. The method according to claim 15, wherein the method further comprises:
creating an event dataset comprising the context information and event information, wherein the event information comprises a function, a binary value indicative of an activation or deactivation event of the function, and a timestamp associated with the activation or deactivation event; and
sending the event dataset to a server using a communication unit of the vehicle.

23. The method according to claim 18, wherein a training dataset is assigned a label classifying the training dataset as member of the first group when the activation duration exceeds a threshold duration.

24. The method according to claim 23, wherein the threshold duration is less than 15 minutes, less than 10 minutes, less than 5 minutes, or 3 minutes.

25. The method according to claim 14, wherein the at least one sensor is a GPS sensor.

26. A non-transitory computer readable medium including instructions that, when executed by at least one processor, cause the at least one processor to:
load a recommendation model;
receive context information acquired from at least one sensor of the vehicle, the context information in particular comprising a geographical location of the vehicle;
determine at least one function including a vehicle function using the context information and the recommendation model; and
provide a function recommendation associated with the vehicle function using a display or a voice assistant of the vehicle.

27. The computer readable medium according to claim 26, wherein the recommendation model classifies the context information as member of a first group or member of a second group with respect to the at least one function, wherein the first group is associated with a supportive experience.

28. The computer readable medium according to claim 26, the computer readable medium further comprising instructions which, when executed by the at least one processor, cause the at least one processor to:
determine a road section based on the geographical location of the vehicle;
wherein the determining of the at least one function further uses at least one key performance indicator of the determined road section, wherein the at least one key performance indicator is a numerical value associated with the at least one function.

29. The computer readable medium according to claim 26, wherein the context information comprises at least one piece of information indicative of: a time or date, a driving speed, a road property, a weather condition, a number of passengers in the vehicle, a mileage of the vehicle, a time expired since start of the trip, a standard deviation of a driving speed.

30. The computer readable medium according to claim 26, wherein the at least one function includes at least one of: cruise control, adaptive cruise control, lane keeping system, lane departure warning, lane change assistance, automatic parking, crosswind stabilization.

31. The computer readable medium according to claim 26, wherein the function recommendation comprises:
an activation incentive on the display of the vehicle;
a sound on a speaker of the vehicle;
a voice assistant of the vehicle; or
modifying programming of a control element such that operating the control element causes sending a control command for activating the vehicle function.

32. A vehicle comprising:
at least one sensor including a position determination sensor;
a computer readable medium storing instructions that when executed by at least one processor cause the at least one processor to:
load a recommendation model;
receive context information acquired from at least one sensor of the vehicle, the context information in particular comprising a geographical location of the vehicle;
determine at least one function including a vehicle function using the context information and the recommendation model; and
provide a function recommendation associated with the vehicle function using a display or a voice assistant of the vehicle; and
a vehicle controller configured to:
a) acquire at least one signal of the at least one sensor;
b) determine the context information based on the acquired signal for feeding to the recommendation model;
c) receive the function recommendation, the function recommendation indicating at least one function to be used and being determined based on an output of the recommendation model; and
d) use the function recommendation to adapt the functionality of the vehicle.

33. The vehicle according to claim 32, wherein the vehicle further comprises a programmable control element provided by a control button, and wherein the vehicle computing unit is further adapted to modify programming of the control element such that operating the control element causes sending a control command for activating at least one function.

34. The vehicle according to claim 32 wherein the at least one sensor is a GPS sensor.
